(19) United States
(12) Patent Application Publication
(10) Pub. No.: US 2003/0212807 A1
(43) Pub. Date: Nov. 13, 2003

(54) Data relay system having Web connection or data relay regulating function and method of controlling regulation of the same

(75) Inventor: Kazuhiro Moriya, Kawasaki-Shi (JP)

Correspondence Address: Richard P. Berg, Esq., c/o LADAS & PARRY, Suite 2100, 5670 Wilshire Boulevard, Los Angeles, CA, 90036-5679, US

(73) Assignee: NETSTAR INCORPORATED

(21) Appl. No.: 10/434,789

(22) Filed: May 8, 2003

(30) Foreign Application Priority Data
May 9, 2002 (JP) 2002-134175

(51) Int. Cl. G06F 15/16

(52) U.S. Cl. 709/229; 713/201; 709/246

(57) ABSTRACT

Provided are a data relay apparatus that can prevent relevant data from being infected with a computer Virus while the Internet user is unaware of that and a method for that data relay apparatus. In a data relay system having a data relay apparatus that relays data communication between a Web server on the Internet and a client, it comprises browser information registering means that registers, as information for use for controlling the connection to the Internet, the browser information that includes information on the kind and version of a browser that the client uses; browser discriminating means that, when accepting a connection request to the Web server from the browser of the client, discriminates the kind and version of the browser that is the connection requesting origin; and Web-connection regulation controlling means that, according to the kind and version information of the browser that has been discriminated and the browser information that has been registered, determines the permission/non-permission of the connection to the Web server that is the connection requesting destination and, when that connection is not permitted, regulates the connection to the Web server.

### BACKGROUND OF THE INVENTION

1. Field of the Invention

The present invention relates to a data relay system that relays data communication between a communication terminal of a user and a WWW (World Wide Web) server system on the Internet, and more particularly to a data relay system having a function to prevent relevant data from being infected with a computer Virus while the Internet user is unaware of that, and a method thereof.

2. Description of the Related Art

Conventionally, as a data relay apparatus that relays data communication between a user's communication terminal and a WWW server on the Internet, there are, for example, a proxy server having a cashing function, etc., a router having a function to control a relay course, etc., and a gateway apparatus having a function to convert a protocol, etc.

Meanwhile, a UA (User Agent) that operates on the client side that receives the service that is offered from the WWW server system is arranged to perform data transmission/reception between the two by the use of an HTTP (Hyper Text Transfer Protocol) as the upper layer of the TCP/IP (Transfer Control Protocol/Internet Protocol) that is a WWW communication protocol. A browser is software that has the role of bringing about, to a user, a clear display of Web contents received from the WWW server, transmitting input made by the user to the Web server, etc As a representative browser, there are Internet Explorer of United States' Microsoft Company and Netscape Navigator of United States' Netscape Company.

In the communication procedure that uses the HTTP, first, a client terminal transmits a request to a server and then receives a response from the server. The result of transmission and reception is determined according to the response from the server. Regarding the HTTP, an HTTP 1.0 the function of that was greatly improved in 1992 from the previous HTTP was defined, and in 1996 was standardized as an RFC 1945. Thereafter, in 1997, an HTTP 1.1 was proposed as RFC (Request for Comments) 2068 and 2069, and at present, an HTTP-NG (HTTP Next Generation) has been developed.

In the above-described RFC 2068 and RFC 2069 protocols, when data is transmitted from the client terminal to the WWW server, the HTTP header information has thereon browser information (the information that represents the kind and version of the browser). Also, on the HTTP header information of the Web data that is transmitted from the WWW server system, there is set Web server system information (the information that represents the kind and version of the Web server). In the WWW server, because the form of displaying (the way of viewing a menu, etc.) is different according to the kind of the browser, at the beginning, the WWW server switched to the menu of the relevant browser by instructing the client to designate the kind of the browser. However, nowadays, it is arranged to recognize the kind of the browser from the HTTP header information by the use of the above-described protocol and to automatically switch to the menu available for the relevant browser and to display.

### SUMMARY OF THE INVENTION

Conventionally, regarding a security of an electronic mail, the relevant technique has coped with it by equipping in a client terminal or data relay apparatus (proxy apparatus, gateway apparatus, etc.) the software that has a function to perform, for example, cipher and decipher of an e-mail, attachment of a signature thereto, detection of interpolation thereof, etc. Also, regarding measures for security that are taken when access is made to a Web server or the like on the Internet, the relevant technique is arranged to prevent unauthorized data from entering the client's interior by equipping the client with a function serving as a firewall, for example. However, the actual circumstance is that complete countermeasures cannot be taken, as in the case where the firewall is broken through. For example, in a data relay apparatus such as a proxy server that relays reading data on the Internet, etc., it relays the Internet communication by the use of the HTTP protocol as stated above. However, there are cases where users are victims caused by the computer Virus, which aims to attack a security hole of the browsers that they use. Therefore, there were required to be aware of connection to the Internet until that the security hole has been corrected. On the other hand, in cases where WWW server systems are infected with Virus, the conventional data relay apparatus transfers data as it is. Therefore, there were some cases where that Virus is relayed to the user's side as well.

The present invention has been made in view of the above-described circumstances and has an object to provide a data relay apparatus that enables regulating data transfer with respect to the browser having a problem in terms of security as well as the connection to the Web server and that thereby enables preventing the relevant data from being infected with a computer Virus while the Internet user is unaware of that, and to provide a method thereof.

The present invention relates to a data relay system. having a data relay apparatus, which relays data communication between a communication terminal of a user and a Web server on the Internet, and more particularly to a method of controlling the regulation of Web connection/data relay in that system. The above object of the present invention, regarding the data relay system, can be attained by comprising browser information registering means that registers, as information for use for controlling the connection to the Internet, the browser information that includes information on the kind and version of a browser that the user uses; browser discriminating means that, when accepting a request to connect to the Web server from the browser of the user, discriminates the kind and version of the browser that is the connection requesting origin; and Web-connection regulation controlling means that, according to the kind and version information of the browser that has been discriminated and the browser information that has been registered, determines permission/non-permission of the connection to the Web server that is the connection requesting destination, and when that connection is not permitted, regulates the connection to the Web server.

Further, the above object can be more effectively attained through each of the respective additional modifications of the data relay apparatus of that the browser discriminating means and the Web-connection regulation controlling means are equipped in the data relay apparatus; the browser discriminating means discriminates the kind and version of the browser according to the header information of a relevant communication protocol; the Web-connection regulation controlling means regulates the connection to the Web server according to the kind and version of the browser that is the connection requesting origin; and the registration, change, and deletion of the browser information that .each is an element for discriminating the permission/non-permission of the connection are enabled from the client side.

Or, the above object can be attained by comprising Web server information registering means that registers, as information for use for controlling the relay of the data, Web server information that includes the information on the kind and version of a Web server; Web server discriminating means that, when transferring Web data from the Web server, discriminates the kind and version of the Web server;. and data relay regulation controlling means that, according to the kind and version information of the Web server that has been discriminated and the Web server information that has been registered, determines in real time the permission/non-permission of the relay of the Web data to the client, and when that relay is not permitted, regulates the relay of the Web data from the Web server.

Further, the above object can be more effectively attained through each of the respective additional modifications of the data relay apparatus of that the Web server discriminating means and the data relay regulation controlling means are equipped in the data relay apparatus; the Web server discriminating means discriminates the kind and version of the Web according to the header information of a relevant communication protocol; the relay of the Web data is regulated according to the kind and version of the Web server that is the transmission origin; and the registration, change, and deletion of the Web server information that each is an element for discriminating the permission/non-permission of the relay can be performed from the client side. In addition, the above object can be more effectively attained by the additional modifications of that the data relay apparatus is a proxy server; and the communication protocol is a protocol that accords with a hyper text transfer protocol.

Also, regarding the invention of the method, the above object can be attained by comprising the steps of discriminating the kind and version of the browser when accepting the connection request from the browser of the client, discrimining the permission/non-permission of the connection to the Web server according to the browser information that includes the kind and the version information of a browser that has been discriminated and the information on the kind and version of a browser that the client uses, which is registered beforehand as the one for controlling the connection to the Internet and thereby regulating that connection, discriminating the kind and version of the Web server when transferring Web data from the Web server, and determining the permission/non-permission of the relay of the Web data destined for transmission to the client according to the Web server information that includes the information on the kind and version of the Web server that is been discriminated and the information on the kind and version of the Web server, which is registered beforehand as the one for controlling the relay of the data and thereby regulating the relay of the data. Also, the discrimination of the kind and version of the browser and the discrimination of the kind and version of the Web server can be more effectively attained according to the header information of the protocol of the data communication.

### BRIEF DESCRIPTION OF THE DRAWINGS

FIG. 1 is a typical view illustrating an example of a construction of a computer network according to the present invention;

FIG. 2 is a typical view illustrating an example of a network construction of a data relay system according to the present invention;

FIG. 3 is a block diagram illustrating a construction example of the data relay system according to the present: invention;

FIG. 4 is a flow chart for explaining control-performed for regulating the utilization of a browser and regulating the connection of the browser to Web according to the present invention;

FIG. 5 is a view illustrating a first concrete example of the form of regulation of Web connection and data relay in the present invention; and

FIG. 6 is a view illustrating a second concrete example of the form of regulation of Web connection and data relay in the present invention.

### DESCRIPTION OF THE PREFERRED EMBODIMENTS

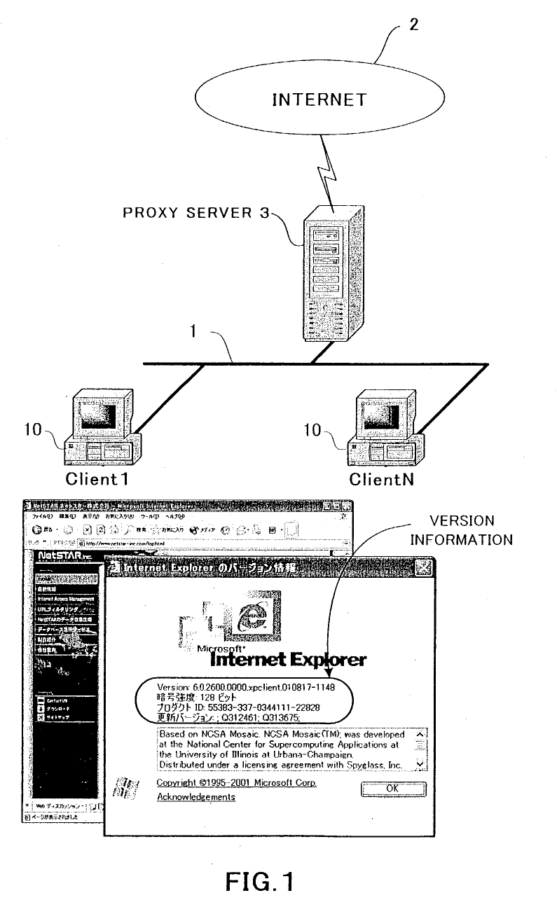

FIG. 1 is a typical view illustrating an example of a construction of a computer network according to the present invention. In the case where, in an organization of an enterprise or the like, accessing the Internet is made possible from each user's personal computer, there has widely adopted the form of accessing wherein, as illustrated in, for example, FIG. 1, a proxy server 3 having a security function and a cash function is connected between a LAN 1 and the Internet 2, whereby accessing the Internet 2 from a user's terminal 10 (hereinafter called “the client”) such as a personal computer via that proxy server 3.

The browser software that is used by the client 10, in the case of, for example, Internet Explorer of the United States' Microsoft Company, as indicated within a circular frame mark in FIG. 1, is arranged to have relevant information that can distinguish between itself and another in terms of the function, improved status, etc. by the code that represents the “Version” and the code that represents the “Update Version”. The code that represents the “Version” is updated, for example, when great improvement, etc. of software has been made. On the other hand, the “Update Version” that is shown by a code string of, for example, “Q312461” in FIG. is aversion that represents the reflected status of a patch program, the correction of that has been performed with respect to various kinds of problems that were contained in that program. For example, when a program has been corrected for performing bug/fix or a small extent of improvement has been performed with respect to it or etc., the version is updated. And it is arranged that, by downloading and executing the patch program that corresponds to the code of the “Update Version”, the corrected codes of the browser be reflected. And it is arranged that, by viewing the “Version” and “Update Version”, what correction (e.g. regarding the security policy) is being reflected in the browser can be determined.

The above-described version information, as exemplified as the conventional technique, is set on the header of the communication protocol (the header of the application layer in this embodiment; and that header is the HTTP protocol header) together with the information regarding the kind of the browser that specifies this browser. Also, information of the WWW server system (the information representing the kind and version of the Web server) is set as the HTTP protocol header information of the Web data that is transmitted from the WWW server system. However, as exemplified as the conventional technique, in the convention computer network system, that information is to such an extent as is used for recognizing the kind of the browser on the WWW server side and was not used for other use purposes.

In the present invention, by, when gaining access to the WWW server system (hereinafter referred to as “the Web server” or “Web server system”), inspecting the kind and version of the browser of the access-requesting origin, and, according to the kind and version of that browser, regulating the accessing of the browser to the Web server, it is intended to prevent damage from being caused by a computer Virus or the like. Also, with respect to the Web server -the connection of that with respect to the client's computer terminal has been permitted, by, when receiving the Web data, inspecting the kind and version of the Web server, and according to the kind and version thereof, regulating the transfer of the Web data to the client, it is intended to prevent damage from being caused by a computer Virus or the like. As data for performing that inspection, it is possible to utilize the header information of the communication protocol of the above-described application layer.

Incidentally, the present invention is not only limited to the proxy server but can be also applied to a router having a function to control a relay course as well as to a gateway apparatus having a function to convert a protocol. Hereinafter, the apparatus that categorically includes those apparatuses and relays data communication between the Web server on the Internet and the client is called “the data relay apparatus”, and further, the system having that data relay apparatus is called “the data relay system”, and under this assumption, a preferred embodiment of the present invention will be explained by showing a concrete example.

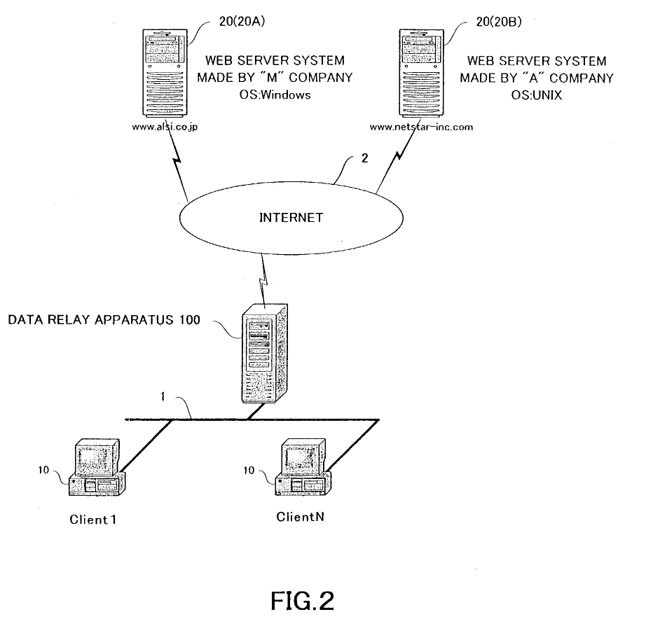

FIG. 2 is a typical view illustrating an example of a network construction of the data relay system according to the present invention. A data relay apparatus 100 is connected between the LAN 1 and the Internet 2, whereby through the intermediary of the data relay apparatus 100 there is relayed data communication between each client 10 (1 to N) and a relevant Web server 20. The kind of the browser that is installed in the client 10 is arbitrary. The kind of the OS (Operating System) of the Web server 20 that is specified by an URL (Uniform Resource Locator) is also arbitrary. The wording “the kind and version of the Web server” referred to in the present invention means the kind of the Web server system and the version of the software operating on that system (for example, a Web server system made by a company A; OS=UNIX, Version xx). In this network construction, a Web-connection regulating function and the data relay regulating function that the data relay system according to the present invention has will hereafter be explained.

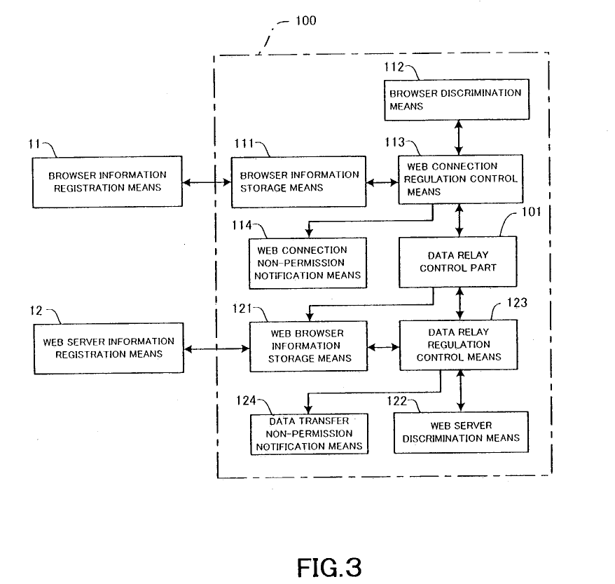

FIG. 3 is a block diagram illustrating a construction example of a main part of the data relay system according to the present invention. The respective means, in this embodiment, are realized by a computer program that is executed by a CPU. The data relay system is constructed of a data relay control part 101 that controls the data relay apparatus 100 as a whole and the following respective means according to the present invention. The browser information registering means 11 and Web server information registering means 12 illustrated in FIG. 3 are provided in the client 10 (or the data relay apparatus 100 or the other managing computers) that is connected to the data relay apparatus 100. The other means 111 to 114 and 121 to 124, in this embodiment, are provided in the data relay apparatus 100 that is connected to the LAN on the client 10 side. Incidentally, the means 111 to 114 associated with the Web-connection regulating function and the means 121 to 124 associated with the data relay regulating function can be also provided in the data relay apparatuses 100 the media of that are different from each other.

First, an explanation will be given of the respective means associated with the Web-connection regulating function (11 and 111 to 114).

In FIG. 3, the browser information registering means 11 is means that is used for registering the “browser information” that includes the kind and version of the browser that the client uses as the one for controlling the connection to the Internet. In this embodiment, the browser that the data relay side permits to use is made to be an object to register, and the kind and version (including an update version) of that browser are registered through the client 10 side's operation. For example, in the case where there is a problem in terms of the security such as a security hole through which Virus is liable to enter and that problem has not been corrected yet, until a patch code becomes reflected on the browser, the invention deletes the information that has been registered for the purpose of regulating the use of that browser.

When performing the new registration of the browser information, the change of the registered contents, and the deletion of them, the user inputs the relevant information according to the registration screen's information displayed on the client 10 and thereby registers it into the data relay apparatus 100. The browser information that has been input, in this embodiment, is stored into the browser information storage means 111 within the data relay apparatus 100. Incidentally, instead, the mode in which to register the information on the browser that the data relay side does not permit to use may be adopted. Or optionally, it may be arranged that the browser information be registered in the way in which, regarding the respective browsers, their kinds and versions are registered beforehand; they are managed by their statuses that indicate the permission/non-permission information of those kinds and versions; and the user instructs permission/non-permission every kind, and every version, of the relevant browsers from the client 10.

The browser discrimination means 112 is means that, when accepting a request to connect to the Web server 20 that is made from the client 10's browser, discriminates the kind and version of the browser that is the connection-requesting origin. In this embodiment, the means 112 discriminates the kind and version of the browser that is the connection-requesting origin according to the information of the connection-requesting application layer. According to the kind and version information of the browser that has been discriminated by the browser discrimination means 112 and the browser information that is registered by the browser information registering means 11, the Web-connection regulating means 113 determines the permission/non-permission of connection to the Web server that is the connection-requesting destination, and if the connection is not permitted, regulates the connection to the Web server. In this embodiment, if not permitted, connection is not made between the client 10 and the Web server, and screen data indicating the non-permission of the use of the browser is transmitted to the client 10 by the Web-connection non-permission notifying means 114. That screen data is displayed on the display part of the client 10 that is the connection-requesting origin. By doing so, the notifying means 114 notifies a message to the effect that the use of the relevant browser is not permitted.

Next, an explanation will be given of the respective means associated with the data relay regulating function and the web-connection regulating function (11 and 111 to 114)

The Web server information registering means 12 is means that is used for registering the “Web server information” that includes the kind and version of the Web server that the data relay side uses as the one for controlling the data relay. In this embodiment, the browser with respect to that the data relay side permits to transfer the data from the Web server system for purpose of, for example, reading of that data, and the kind and version of that browser are registered as the Web server information through the client 10 side's operation. In the case where the use of the Web server system is not permitted, such as, for example, in the case where there is a problem in terms of the security such as the possibility that relevant data will be infected with Virus due to the download of reading data (HTML, XML, etc.) and software and that problem has not been solved yet, until the countermeasure has been taken with respect thereto, the means 12 deletes the registration.

When performing the new registration of the Web server information, the change of the registered contents, and the deletion of them, as in the case of the browser information, the user inputs the relevant information according to the registration screen's information displayed on the client 10 and thereby registers it into the data relay apparatus 100. The Web server information that has been input, in this embodiment, is stored into the Web server information storage means 121 within the data relay apparatus 100. Incidentally, as in the case of the browser information, instead, the mode in which to register the Web server information on the Web server system that the data relay side does not permit to use may be adopted. Or optionally, it may be arranged that the Web server information be registered in the way in which, regarding the respective Web server systems, their kinds and versions are registered beforehand; they are managed by their statuses that indicate the permission/non-permission information of those kinds and versions; and the user instructs permission/non-permission every kind, and every version, of the relevant Web server systems from the client 10. However, although the same applies to the browsers, it may be arranged that the Web server systems that the relay side permits to use be registered beforehand and all the other Web server systems be left out of permission. This form of registration is more preferable because only the Web server systems that are safe become able to be used.

The Web server discrimination means 122 is means that, when transferring Web data from the Web server 20, discriminates the kind and version of the Web server 20 that is the transmission origin. In this embodiment, the means 122 discriminates the kind and version of the Web server according to the header information of the Web data application layer. According to the kind and version information of the Web server that is discriminated by the Web server discrimination means 122 and the Web server information that is registered by the Web server information registering means 12, the data relay regulation controlling means 123 determines in real time the permission/non-permission of relay with respect to the client 10 of Web data that has been transmitted from the Web server 20 and, if the relay is not permitted, regulates the relay of the Web data from the Web server 20 that is the transmission origin. In this embodiment, if not permitted, the Web data is not relayed (transferred) to the client 10, and screen data indicating the non-permission of the use of the Web server 20 is transmitted to the client 10 by the data transfer non-permission notifying means 124. That screen data is displayed on the display part of the client 10. By doing so, the notifying means 124 notifies a message to the effect that the use of the relevant Web server system is not permitted.

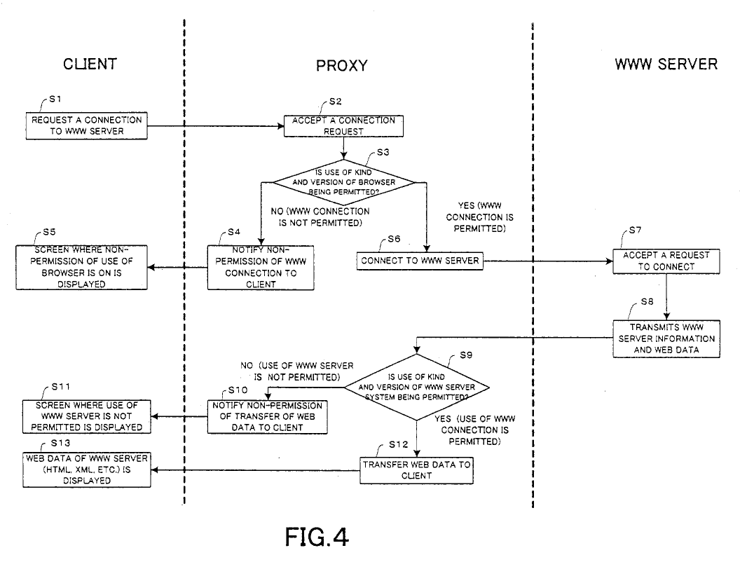

The control that, in the construction that is described above, is performed on regulating the use of the browser in the. data relay apparatus according to the present invention and regulating the connection of the browser to the Web server will be explained with reference to a flow chart of FIG. 4. Incidentally, in the data relay apparatus having a cashing function, it may be arranged that, when transferring cashing data, inspection is performed whether or not the Web server that is the transmission origin of that data is permitted. However, since the data that has been cash processed is already permitted to be transferred through the inspection that is made when reception is made, that data is not made to be an object to inspect but a method wherein that data is transferred intact is used.

In the data relay apparatus (the “PROXY” in FIG. 4) ,upon reception of a request to connect from the client's browser to the Web-server (WWW server) (steps S1 and S2), the relay apparatus discriminates the kind and version of the browser of the connection requesting origin according to the header information of the connection request. Then, the relay apparatus inspects whether or not the use of the kind or version of that browser is registered as being “the permission” (or “the non-permission”) (step S3). When the relay apparatus has determined that the use is not permitted, it does not transmit the connection request from the client to the Web server but transmits screen data representing the non-permission of the to Web connection (the non-permission of the use of the browser) to the client (step S4). By doing so, the relay apparatus displays the relevant screen on the display part of the client that is the connection requesting origin to thereby notify that non-permission to the client (step S5). On the other hand, in the case where it has been determined in the inspection of the step 53 that the use is being permitted, the relay apparatus transmits the connection request made-from the client to the Web server (step S6) to thereby connect the client and the Web server (step S7).

When Web server information (in this embodiment the Web server information that is set on the header of the HTTP protocol) and Web data are transmitted from the Web server (step S8), in the data relay apparatus it discriminates the kind and version of the Web server according to the header information. Then, the relay apparatus inspects whether or not the use of the kind or version of that Web server that is the transmission origin is registered as being “the permission” (or “the non-permission”) (step S9) . When the relay apparatus has determined that that use is not permitted, it does not transmit the Web data to the client but transmits screen data representing the non-permission of the transfer of the Web data (the non-permission of the use of the Web server) to the client (step S10). By doing so, the relay apparatus displays the relevant screen on the display part of the client that is the connection requesting origin to thereby notify that non-permission to the client (step S11).

On the other hand, in the case where it has been determined in the inspection of the step S9 that that use is being permitted, the relay apparatus transmits the Web data that has been received from the Web server to the client (step S12) and displays the Web data (HTML, XML, etc.) on the display part of the client (step S13) In the above-described way, in the data relay system according to the present invention, it is arranged that the transfer of data to the browser, or the connection to the Web server, which has a problem in terms of the security be regulated, to thereby enable preventing the data from being infected with computer Virus while the Internet user is unaware of that.

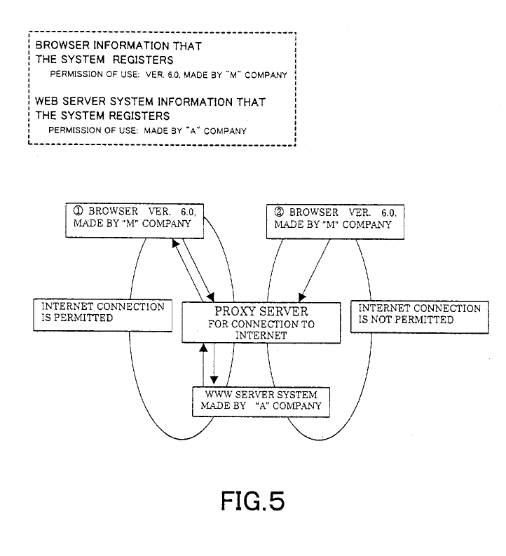

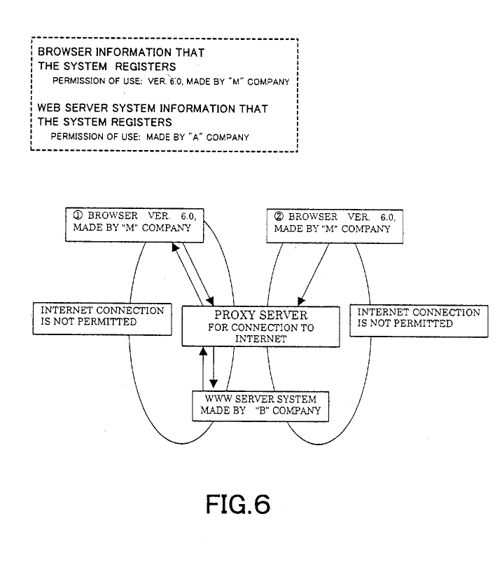

FIGS. 5 and 6 illustrate a concrete regulation example of the Web-connection and data relay. With reference to these figures, an explanation will be given of the methods of regulating according to the kind and version of each of the browser and Web server.

As a first regulation example, it is assumed that, as illustrated in FIG. 5, the browser ver. 6.0 made by “M” company be registered as being “permission to use” and the Web server system made by “A” company be registered as being “permission to use”. In this case, the regulated results in the data relay system are as follows.

Regarding the connection request made from the browser of the client<1>, since the version of the browser that is being used and the Web server system that is the connection requesting origin are both permitted to be used, that client can receive the Web data and the user can read it.

Regarding the connection request made from the browser of the client<2>, the browser that is being used is different from the version (Ver. 6.0) that is kept registered and, for this reason, is not permitted to be used. Therefore, connection to the Web server is not performed. Therefore, the client cannot receive the Web data.

As a second regulation example, it is assumed that, as illustrated in FIG. 6, the registered contents be the same as those described above and the software be utilized as illustrated in FIG. 6. In this case, the regulated results are as follows.

Although the version of the browser used in the client <1>is the same as the registered version and therefore this browser is permitted to be used, because the Web server system (made by “B” company) that is the connection requesting destination is not permitted to be used, the client cannot receive the Web data.

Regarding the connection request made from the browser of the client<2>, because the version of the browser that is being used is different from the registered version (Ver. 6. 0) and therefore is not permitted to be used, connection to the Web server is not performed. Therefore, the client cannot receive the Web data.

In the above-described way, every kind, and every version, of the browsers, and every kind, and every version of the Web server system, permission/non-permission are determined. Thereby, connection to the Web server system and relay of the Web data are regulated.

Incidentally, although in the above-described embodiment an explanation has been given having taken up as an example the case where permission/non-permission is determined depending on whether or not the version of the browser going to be used and the version of the software of the Web server system going to be used each are kept registered, it may be arranged that permission/non-permission be determined according to the threshold value or the range of the version in the way, for example, in which if the version is equal to or higher than α the browser is permitted, and if the version is lower than α the browser is not permitted. Also, in the above-described embodiment, regarding the registration of the browser information and Web server information, an explanation has been given of the case where registration is made by an instruction's being made by a person. However., a mode may be adopted wherein registration is automatically or semi-manually made, for example, by receiving the security information of that software from a prescribed managing computer.

As has been explained above, according to the present invention, on the data relay apparatus that is utilized when performing the connection to the Internet, it is arranged that the kind and version of the browser that the client is using be inspected, and, according to the kind and version of the browser, permission/non-permission be made of the connection to the Web server system. Therefore, it is possible to prevent relevant data from being infected with a computer Virus while the Internet user is unaware of that. In addition, it is arranged that control of the relay of the data regarding whether or not data should be transmitted to the client side be performed according to the kind and version of the Web server system that is the connection destination of the client. Therefore, it becomes possible to safely utilize the Internet without the user'being aware of the site, etc. the security of that is low and that therefore is thought dangerous.

What is claimed is:

1. A data relay system, the data relay system having a data relay apparatus that relays data communication between a Web server on the Internet and a client, comprising
browser information registering means that registers, as information for use for controlling the connection to the Internet, the browser information that includes information on the kind and version of a browser that the client uses; browser discriminating means that, when accepting a connection request to the Web server from the browser of the client, discriminates the kind and version of the browser that is the connection requesting origin; and Web-connection regulation controlling means that, according to the kind and version information of the browser that has been discriminated and the browser information that has been registered, determines the permission/non-permission of the connection to the Web server that is the connection requesting destination, and when that connection is not permitted, regulates the connection to the Web server.

2. A data relay system according to claim 1, wherein the browser discriminating means and the Web-connection regulation controlling means are equipped in the data relay apparatus.

3. A data relay system according to claim 1, wherein the browser discriminating means is arranged to discriminate the kind and version of the browser according to header information of a relevant communication protocol.

4. A data relay system according to claim 1, wherein the Web-connection regulation controlling means is arranged to regulate the connection to the Web server according to the kind and version of the browser that is the connection requesting origin.

5. A data relay system according to claim 1, wherein the registration, change, and deletion of the browser information that each is an element for discriminating the permission/non-permission of the connection can be performed from the client side.

6. A data relay system according to claim 1, wherein the data relay apparatus is a proxy server.

7. A data relay system according to claim 3, wherein the communication protocol is a protocol that accords with a hyper text transfer protocol.

8. A data relay system, the data relay system having a data relay apparatus that relays data communication between a Web server on the Internet and a client, comprising
Web server information registering means that registers as information for use for controlling the relay of the data Web server information that includes information on the kind and version of a Web server; Web server discriminating means that, when transferring Web data from the Web server, discriminates the kind and version of the Web server; and data relay regulation controlling means that, according to the kind and version information of the Web server that has been discriminated and the Web server information that has been registered, determines in real time the permission/non-permission of the relay of the Web data to the client, and when that relay is not permitted, regulates the relay of the Web data from the Web server.

9. A data relay system according to claim 8, wherein the Web server discriminating means and the data relay regulation controlling means are equipped in the data relay apparatus.

10. A data relay system according to claim 8, wherein the Web server discriminating means is arranged to discriminate the kind and version of the Web server according to the header information of a relevant communication protocol.

11. A data relay system according to claim 8, wherein the data relay regulation-controlling means is arranged to regulate the relay of the Web data according to the kind and version of the Web server that is the transmission origin.

12. A data relay system according to claim 8, wherein the registration, change, and deletion of the Web server information that each is an element for discriminating the permission/non-permission of the relay can be performed from the client side.

13. A data relay system according to claim 8, wherein the data relay apparatus is a proxy server.

14. A data relay system according to claim 10, wherein the communication protocol is a protocol that accords with a hyper text transfer protocol.

15. A method of controlling the regulation of Web-connection/data relay, the method of controlling the regulation of Web-connection/data relay being executed in a data relay system having a data relay apparatus that relays data communication between a Web server on the Internet and a client, comprising the steps of:
when accepting a connection request from the browser of the client, discriminating the kind and version of the browser, determining the permission/non-permission of the connection to the Web server according to the browser information that includes the information on the kind and version of the browser that has been discriminated and the information on the kind and version of the browser that the client uses, which is registered beforehand as the one for controlling the connection to the Internet and thereby regulating that connection, discriminating the kind and version of the Web server when transferring Web data from the Web server, and determining the permission/non-permission of the relay of the Web data destined for transmission to the client according to the Web server information that includes the information on the kind and version of the Web server that has been discriminated and the information on the kind and version of the Web server, which is registered beforehand as the one for controlling the relay of the data and thereby regulating the relay of the data..

16. A method of controlling the regulation of Web-connection/data relay according to claim 15, wherein the discrimination of the kind and version of the browser and the discrimination of the kind and version of the Web server are performed according to the header information of the protocol for use on the data communication.
